(19) United States
(12) Patent Application Publication
(10) Pub. No.: US 2021/0150421 A1
(43) Pub. Date: May 20, 2021

(54) Dynamic Management of Virtual Queues

(71) Applicant: Disney Enterprises, Inc., Burbank, CA (US)

(72) Inventors: Seth Abbe, Montverde, FL (US); Michael Nightingale, Ladera Ranch, CA (US); Todd Graham, Lewis Center, CA (US); Alexander Logan Meyer, Los Angeles, CA (US); Joshua Caleb Umstead, Los Angeles, CA (US); Robert Todd Ogrin, Saugus, CA (US); Paul David Fisher, Orange, CA (US); Zulekha Banu Flexwala, Encino, CA (US); Jason Daniel Smith, Anaheim, CA (US); Brandon J. Pastuszek, Los Angeles, CA (US); Ramkrish Raja, Chester Springs, CA (US); Amy Elizabeth Nelson, Los Angeles, CA (US)

(73) Assignee: Disney Enterprises, Inc.

(21) Appl. No.: 16/688,006

(22) Filed: Nov. 19, 2019

(51) Int. Cl. G06Q 10/02; G06F 9/445

(52) U.S. Cl. CPC G06Q 10/02; G06F 9/44521

(57) ABSTRACT

A dynamic queue management system includes a computing platform having a hardware processor and a memory storing a software code. The hardware processor executes the software code to receive queue enrollment data identifying a first guest and a first attraction, determine whether the first guest is enrolled in a second queue for a second attraction, and assign the first guest to one of multiple groups seeking admission to the first attraction based on whether the first guest is enrolled in the second queue. The software code further obtains a current occupancy state of the first attraction, determines an attendance period corresponding to an average duration of attendance at the first attraction by previous guests, and identifies one of the groups for admission to the first attraction based on the number of guests in the group, the current occupancy state of the first attraction, and the attendance period of the attraction.

### BACKGROUND

A popular attraction in a shopping mall, resort property, or recreation area, for example, may need to restrict its occupancy in the interests of safety, or simply to optimize the experience of those guests granted admission to the attraction. One conventional and time honored approach to limiting the number of guests occupying an attraction at the same time include use of a waiting line or queue to delay the admission of guests while honoring the order in which the waiting guests arrived. Despite being an effective way to limit entry and prevent overcrowding of an attraction, the use of physical queues has several significant drawbacks.

One drawback of requiring guests to wait in a queue is the psychological and physical toll that a prolonged wait can impose on those guests. As common experience will testify, waiting in line is at best tedious and, depending on the length of the wait and environmental conditions, may be physically uncomfortable. Another drawback of physical queues is that they prevent a guest waiting in line from enjoying other attractions available in the same venue, which may further frustrate the waiting guests while also depriving other attractions of traffic and potential revenue. Depending on the length of the queue, a physical queue can also have unpleasant consequences for other users of the venue, for example, by congesting public spaces and restricting freedom of movement for non-queueing users of the venue.

### SUMMARY

There are provided systems and methods for providing dynamic management of virtual queues, substantially as shown in and/or described in connection with at least one of the figures, and as set forth more completely in the claims.

### BRIEF DESCRIPTION OF THE DRAWINGS

FIG. 1 shows a diagram of an exemplary system for providing dynamic management of virtual queues, according to one implementation;

FIG. 2 shows another exemplary implementation of a system for providing dynamic management of virtual queues;

FIG. 3 is a flowchart presenting an exemplary method for use by a system to provide dynamic management of virtual queues; and

FIG. 4 shows an exemplary diagram of a dynamic queue management software code suitable for execution by a hardware processor of the systems shown in FIGS. 1 and 2.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for providing dynamic management of virtual queues that overcome the drawbacks and deficiencies in the conventional art. The systems and methods disclosed herein advantageously enable the management of large, fluctuating guest demand for a limited capacity attraction in real-time, while simultaneously mitigating fraud and ensuring the attraction is never starved of a guest population. In some implementations, the present dynamic queue management solution may be performed as a substantially automated process by a substantially automated system.

It is noted that, as used in the present application, the terms “automation,” “automated”, and “automating” refer to systems and processes that do not require the participation of a human user, such as an attraction operator or supervisor. Although, in some implementations, a human operator or supervisor may review the dynamic queuing determinations made by the automated systems and according to the automated methods described herein, that human involvement is optional. Thus, the methods described in the present application may be performed under the control of hardware processing components of the disclosed automated systems.

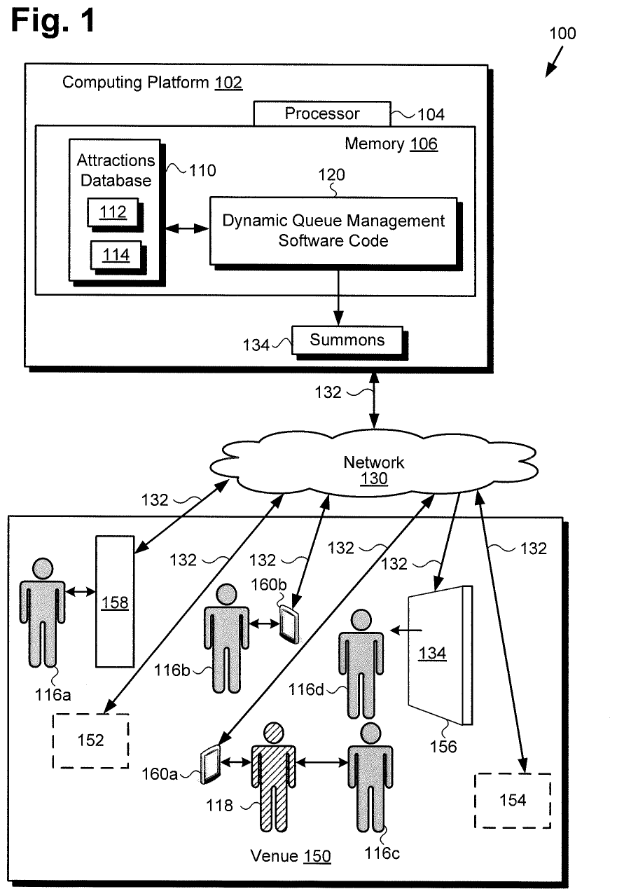

FIG. 1 shows a diagram of an exemplary system for providing dynamic management of virtual queues, according to one implementation. As shown in FIG. 1, system 100 can include computing platform 102 having hardware processor 104, and memory 106 implemented as a non-transitory storage device. According to the implementation shown in FIG. 1, memory 106 stores dynamic queue management software code 120 and attractions database 110 including queue metrics 112 and 114 describing the virtual queues being managed for respective first attraction 152 and second attraction 154 of venue 150. It is noted that, as also shown in FIG. 1, dynamic queue management software code 120, when executed by hardware processor 104, is configured to output summons 134 to a group of guests granted admission to one of first attraction 152 or second attraction 154.

As further shown in FIG. 1, system 100 is implemented within a use environment including communication network 130 and network communication links 132 communicatively coupling system 100 to features within venue 150, such as first and second attractions 152 and 154, public display screen 156 displaying summons 134, ticketing kiosk 158, and mobile communication devices 160a and 160b. Also shown in FIG. 1 are guests 116a, 116b, 116c, and 116d (hereinafter “guests 116a-116d”) of venue 150, as well as operator 118 of first attraction 152.

It is noted that, although the present application refers to dynamic queue management software code 120 as being stored in memory 106 for conceptual clarity, more generally, memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102, or to a hardware processor of any of mobile communication devices 160a and 160b. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

It is also noted that although FIG. 1 depicts dynamic queue management software code 120 and attractions database 110 as being co-located in memory 106, that representation is also provided merely as an aid to conceptual clarity. More generally, system 100 may include one or more computing platforms 102, such as computer servers for example, which may form an interactively linked but distributed system, such as a cloud-based system, for instance. As a result, hardware processor 104 and memory 106 may correspond to distributed processor and memory resources within system 100.

In one implementation, for example, computing platform 102 of system 100 may correspond to one or more web servers, accessible over a packet-switched network such as the Internet. Alternatively, computing platform 102 may correspond to one or more computer servers supporting a wide area network (WAN), a local area network (LAN), or included in another type of limited distribution or private network.

System 100 is configured to provide dynamic management of virtual queues for attractions included in venue 150, such as first attraction 152 and second attraction 154, and may be configured to do so as a substantially automated system. In some implementations, venue 150 may take the form of an indoor venue. Examples of such indoor venues include a shopping mall, a cruise ship, a casino, or an enclosed sports arena, to name a few. Alternatively, in some implementations, venue 150 may take the form of an outdoor venue. Examples of such outdoor venues include an open air sports arena or stadium, a resort property, and a theme park, again to name merely a few. As a specific example, in implementations in which venue 150 is a theme park, one or both of first attraction 152 and second attraction 154 may be a theme park entertainment venue or a theme park ride.

It is noted that although only two attractions are shown in FIG. 1 in the interests of conceptual clarity, in other implementations, system 100 may be configured to provide dynamic queue management concurrently for more, or many more than two attractions, such as hundreds, or thousands of attractions, for example. It is further noted that although FIG. 1 depicts four guests 116a-116d in venue 150, once again that representation is in the interests of conceptual clarity. More generally, guests 116a-116d may correspond to thousands, tens of thousands, hundreds of thousands, or millions of guests of venue 150.

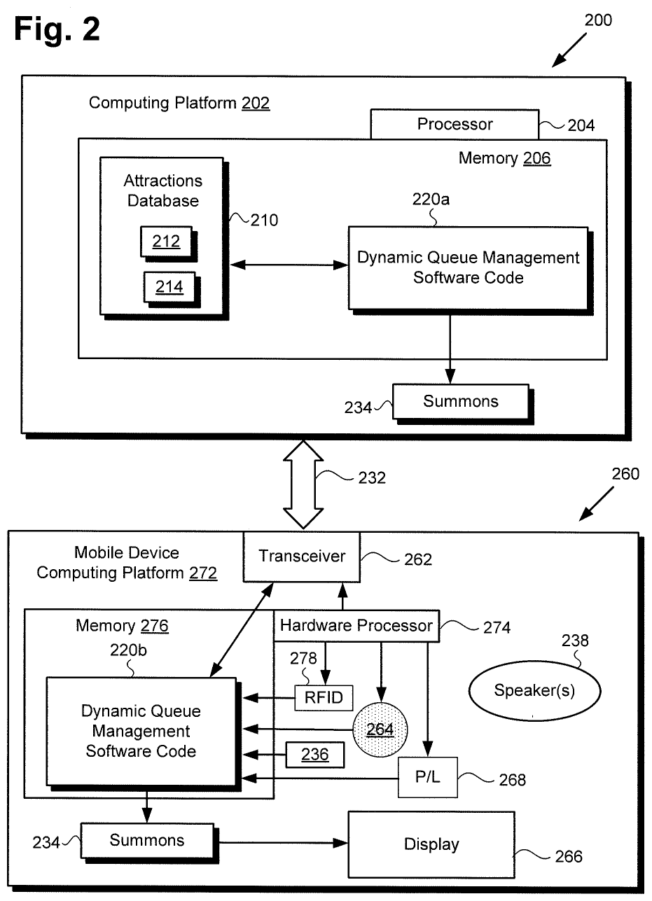

FIG. 2 shows another exemplary implementation of a system for providing dynamic management of virtual queues. According to the exemplary implementation shown in FIG. 2, mobile communication device 260 is interactively connected to system 200 over network communication link 232. Network communication link 232, and system 200 including computing platform 202 having hardware processor 204 and memory 206 correspond in general to network communication link 132, and system 100 including computing platform 102 having hardware processor 104 and memory 106, in FIG. 1. Moreover, dynamic queue management software code 220a and attractions database 210 including queue metrics 212 and 214, in FIG. 2, correspond respectively in general to dynamic queue management software code 120 and attractions database 110 including queue metrics 112 and 114, in FIG. 1. Thus, attractions database 210, queue metrics 212 and 214, and dynamic queue management software code 220a may share any of the characteristics attributed to attractions database 110, queue metrics 112 and 114, and dynamic queue management software code 120 by the present disclosure, and vice versa.

As further shown in FIG. 2, mobile communication device 260 includes mobile device computing platform 272 having hardware processor 274 and memory 276 implemented as a non-transitory storage device storing dynamic queue management software code 220b. In addition, mobile communication device 260 includes transceiver 262, display 266, and position/location sensor(s) 268. Also shown in FIG. 2 are optional camera 264, acoustic sensor or sensors 236 (hereinafter “acoustic sensor(s) 236”), one or more speakers 238 (hereinafter “speaker(s) 238”), radio-frequency identification (RFID) reader 278, and summons 234 generated by system 100/200 or by mobile communication device 260.

Transceiver 262 may be implemented as a wireless communication unit enabling mobile communication device 260 to exchange data with system 100/200 via communication network 130 and network communication links 132/232. For example, transceiver 262 may be implemented as a fourth generation (4G) wireless transceiver, or as a 5G wireless transceiver configured to satisfy the IMT-2020 requirements established by the International Telecommunication Union (ITU). Position/location sensor(s) 268 may include one or more accelerometers, and/or gyroscopes, and/or a GPS receiver, and/or a magnetometer, for example. In some implementations, position/location sensor(s) 268 may be implemented as an inertial measurement unit (IMU), as known in the art.

Display 266 may take the form of a single display screen, or multiple display screens. It is noted that display 266 including one or more display screens, as well as public display screen 156 in FIG. 1, may be implemented as liquid crystal displays (LCDs), light-emitting diode (LED) displays, organic light-emitting diode (OLED) displays, or any other suitable display screens that perform a physical transformation of signals to light. When included as part of mobile communication device 260, camera 264 may include a still image camera and/or a video camera. Moreover, in some implementations, camera 264 may correspond to an array of still image and/or video cameras configured to generate a panoramic image of a venue, such as venue 150, in FIG. 1.

Mobile communication device 260, in FIG. 2, corresponds in general to either or both of mobile communication devices 160a and 160b, in FIG. 1. Thus, mobile communication devices 160a and 160b may share any of the characteristics attributed to mobile communication device 260 by the present disclosure, and vice versa. That is to say, although not shown in FIG. 1, each of mobile communication devices 160a and 160b may include features corresponding respectively to transceiver 262, display 266, position/location sensor(s) 268, hardware processor 274, and memory 276 storing dynamic queue management software code 220b, and may further include a feature or features corresponding to camera 264, acoustic sensor(s) 236, speaker(s) 238, and RFID reader 278.

It is noted that although mobile communication device 160a/160b/260 is depicted as a smartphone in FIG. 1, that representation is merely exemplary. More generally, mobile communication device 160a/160b/260 may be any suitable mobile computing device or system that implements data processing capabilities sufficient to provide a user interface, support connections to communication network 130, and implement the functionality ascribed to mobile communication device 160a/160b/260 herein.

For example, in other implementations, mobile communication device 160a/160b/260 may take the form of a tablet computer, or a wearable personal communication device, such as an augmented reality (AR) or virtual reality (VR) headset or glasses, a smartwatch, or another smart personal item worn by one or more of guests 116a-116d or operator 118 of first attraction 152. Moreover, in some implementations, mobile communication device 160a/260 used by operator 118 of first attraction 152 may take the form of a handheld or otherwise portable ticketing system or may itself be configured to provide dynamic management of the virtual queue for first attraction 152.

According to the exemplary implementation shown in FIG. 2, dynamic queue management software code 220b is located in memory 276 of mobile communication device 160a/160b/260, having been received from system 100/200 via network communication link(s) 132/232. In one implementation, network communication link(s) 132/232 correspond(s) to transfer of dynamic queue management software code 220b over a packet-switched network such as the Internet, for example. Once transferred, for instance by being downloaded over network communication link(s) 132/232, dynamic queue management software code 220b may be persistently stored in memory 276 and may be executed locally on mobile communication device 160a/160b/260 by hardware processor 274.

Hardware processor 274 may be the central processing unit (CPU) for mobile communication device 160a/160b/260, for example, in which role hardware processor 274 runs the operating system for mobile communication device 160a/160b/260 and executes dynamic queue management software code 220b. In some implementations, dynamic queue management software code 220b may be a thin client application resident on mobile communication device 160a/160b/260 and configured to operate as a client of host dynamic queue management software code 120/220a of system 100/200. For example, in those implementations dynamic queue management software code 220b may transmit guest data, such as location data obtained using position/location sensor(s) 268, RFID reader 278, camera 264, or acoustic sensor(s) 236 to system 100/200. In addition, in those implementations, dynamic queue management software code 220b may be configured to receive summons 134/234 output by system 100/200, and to transmit communication summons 134/234 to the guest in possession of mobile communication device 160a/260, for example, via display 266 or speaker(s) 238.

However, in other implementations, dynamic queue management software code 220b may correspond in general to dynamic queue management software code 120/220a, and when executed by hardware processor 274, may be capable of performing substantially all of the operations attributed to dynamic queue management software code 120/220a by the present disclosure. Thus, in some implementations, mobile communication device 160a/260 may itself implement a system for providing dynamic management of virtual queues.

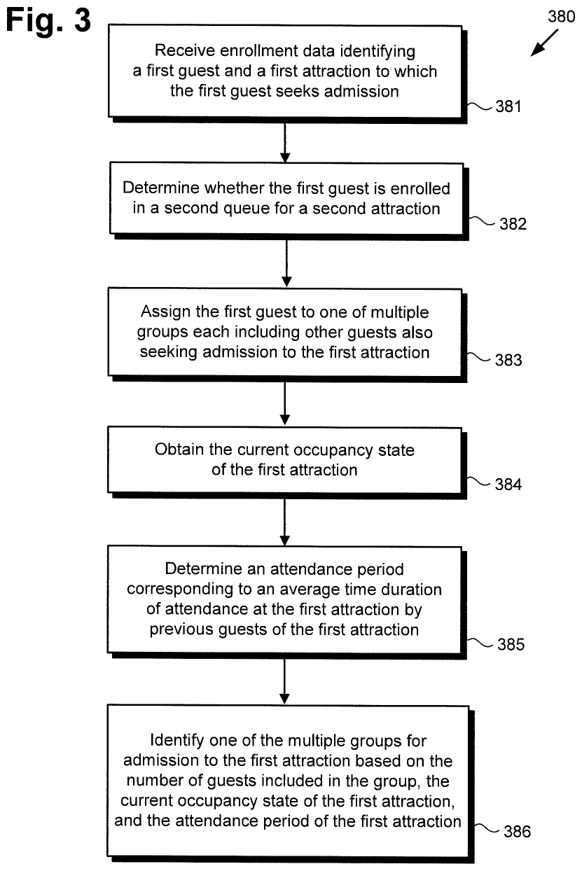

The functionality of dynamic queue management software code 120/220a/220b will be further described by reference to FIG. 3 in combination with FIGS. 1, 2, and 4. FIG. 3 shows flowchart 380 presenting an exemplary method for use by a system to provide dynamic management of virtual queues. With respect to the method outlined in FIG. 3, it is noted that certain details and features have been left out of flowchart 380 in order not to obscure the discussion of the inventive features in the present application.

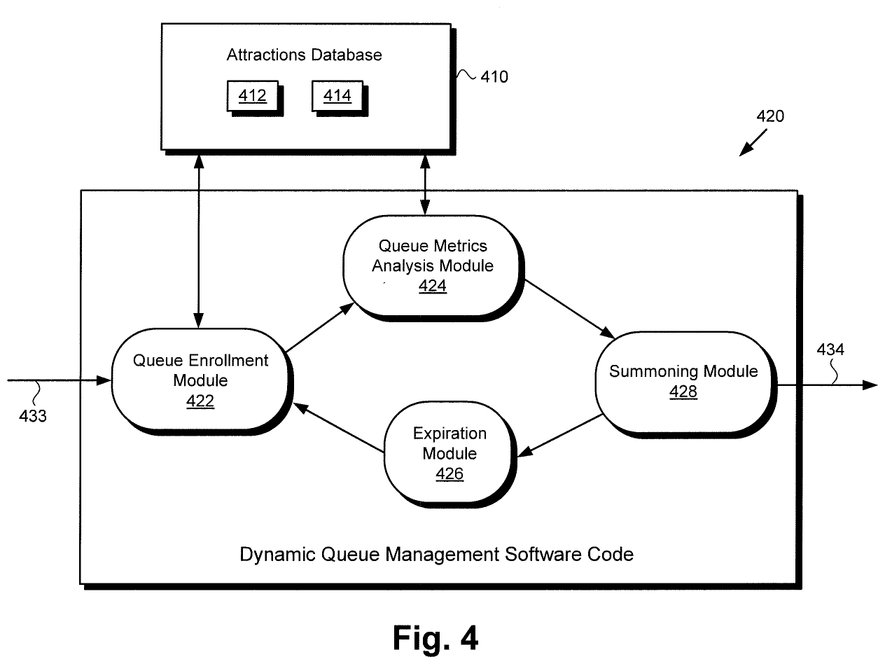

FIG. 4 shows an exemplary diagram of dynamic queue management software code 420 suitable for execution by a hardware processor of the systems shown by FIGS. 1 and 2, according to one implementation. As shown in FIG. 4, dynamic queue management software code 420 may include queue enrollment module 422, queue metrics analysis module 424, expiration module 426, and summoning module 428. In addition, FIG. 4 shows queue enrollment data 433 and summons 434. Also shown in FIG. 4 is attractions database 410 including queue metrics 412 and 414.

Summons 434, attractions database 410, and queue metrics 412 and 414 correspond respectively in general to summons 134/234, attractions database 110/210, and queue metrics 112/212 and 114/214 in FIGS. 1 and 2, and may share any of the characteristics attributed to those corresponding features by the present disclosure, and vice versa. Moreover, dynamic queue management software code 420 corresponds in general to dynamic queue management software code 120/220a/220b. That is to say, like dynamic queue management software code 420, dynamic queue management software code 120/220a/220b may include modules corresponding respectively to queue enrollment module 422, queue metrics analysis module 424, expiration module 426, and summoning module 428. It is noted that in implementations in which dynamic queue management software code 220b/420 is stored in memory 276 of mobile communication device 160a/160b/260 and is executed locally on mobile communication device 160a/160b/260 by hardware processor 274, attractions database 110/210/410 may be accessible to dynamic queue management software code 220b/420 via communication network 130 and network communication link(s) 132/232.

Referring to FIG. 3 in combination with FIGS. 1, 2, and 4, flowchart 380 begins with receiving queue enrollment data 433 identifying a first guest, i.e., one of guests 116a-116d, and first attraction 152 to which the first guest seeks admission (action 381). There are a variety of use cases corresponding to action 381. For example, in some instances it may be advantageous or desirable for guest 116a to enroll in a virtual queue for first attraction 152 using ticketing kiosk 158 communicatively coupled to system 100/200 via communication network 130. In that use case, inputs provided to ticketing kiosk 158 by guest 116a result in queue enrollment data 433 for guest 116a being received by queue enrollment module 422 of dynamic queue management software code 120/220a/420, executed by hardware processor 104/204.

Alternatively, in some instances it may be advantageous or desirable for guest 116d to enroll in a virtual queue for first attraction 152 through direct interaction with operator 118 of first attraction 152. In that use case, inputs provided to mobile communication device 160a/260 by operator 118 of first attraction 152 on behalf of guest 116d may result in queue enrollment data 433 for guest 116d being received by queue enrollment module 422 of dynamic queue management software code 120/220a/420, executed by hardware processor 104/204, via communication network 130 and network communication link(s) 132/232.

As another alternative, in some instances it may be advantageous or desirable for guest 116b to use a personal communication device owned or merely in the possession of guest 116b, such as mobile communication device 160b/260, to enroll in a virtual queue for first attraction 152. In those use cases, queue enrollment data 433 may be generated by mobile communication device 160b/260, and may be subsequently transmitted to system 100/200 via communication network 130 and network communication link(s) 132/232. In such implementations, queue enrollment data 433 may be received from mobile communication device 160b/260 by queue enrollment module 422 of dynamic queue management software code 120/220a/420, executed by hardware processor 104/204.

As yet another alternative, and as noted above, in some implementations, dynamic queue management software code 220b/420 stored locally on memory 276 of mobile communication device 160a/160b/260 may correspond substantially in full to dynamic queue management software code 120/220a/420. In those implementations, queue enrollment data 433 may be received as inputs to mobile communication device 160a/160b/260, by operator 118 of first attraction 152 or by guest 116b, for example, and may be received by queue enrollment module 422 of dynamic queue management software code 220b/420, executed by hardware processor 274.

It is noted that queue enrollment data 433 may be processed by queue enrollment module 422 of dynamic queue management software code 120/220a/220b/420 and may be stored in attractions database 110/210/410 as part of queue metrics 112/212/412 for the virtual queue being dynamically managed by system 100/200 or mobile communication device 160a/160b/260 for first attraction 152. In addition to data identifying the first guest being enrolled in action 381, queue metrics 112/212/412 may include a variety of real-time operating metrics of first attraction 152. Such real-time operating metrics may include the current occupancy state of first attraction 152, its maximum occupancy, and an attendance period corresponding to the average time duration of attendance at first attraction 152 by previous guests of first attraction 152, for example.

However, it is further noted that despite including data distinguishing the first guest identified by queue enrollment data 433 from other guests enrolled in the virtual queue for first attraction 152, queue metrics 112/212/412 do not include personally identifiable information (PII) of queue enrolled guests. Thus, although dynamic queue management software code 120/220a/220b/420 is typically able to distinguish one of guests 116a-116d of venue 150 from another of guests 116a-116d, system 100/200 and dynamic queue management software code 120/220a/220b/420 are not configured to retain information describing the age, gender, race, ethnicity, or any other PII of any guests of venue 150.

It is also noted that queue enrollment data 433 may be provided by a single guest for enrollment of a self-identified group of guests. For example, where guests 116c and 116d are friends, family members, or merely wish to be admitted to first attraction 152 together, either of guests 116c or 116d may provide queue enrollment data 433 for enrolling both of guests 116c and 116d in the virtual queue for first attraction 152. In use cases where queue enrollment data 433 is used to enroll a self-identified group, queue enrollment data 433 identifies all individual members of the self-identified group, as well as the attraction to which the self-identified group seeks admission.

Flowchart 380 continues with determining whether the first guest is enrolled in a second virtual queue for second attraction 154 to which the first guest also seeks admission (action 382). As noted above, the guest described as the “first guest” in the method outlined by flowchart 380 may be any one of guests 116a-116d. A determination of whether the first guest is enrolled in the second virtual queue for second attraction 154 may be performed by reference to queue metrics 114/214/414 for that second queue. For example, queue metrics 114/214/414 may be parsed or otherwise analyzed to determine if the first guest identified by queue enrollment data 433 in action 381 is included among guests queued for second attraction 154.

As noted above, in some implementations, queue enrollment data 433 may be received by system 100/200. In those implementations, determination of whether the first guest is enrolled in the second virtual queue for second attraction 154 may be performed by dynamic queue management software code 120/220a/420, executed by hardware processor 104/204, and using queue metrics analysis module 424. Alternatively, and as also noted above, in some implementations, dynamic queue management software code 220b/420 stored locally on memory 276 of mobile communication device 160a/160b/260 may correspond substantially in full to dynamic queue management software code 120/220a/420. Thus, in some implementations, action 382 may be performed by dynamic queue management software code 220b/420, executed by hardware processor 274, and using queue metrics analysis module 424 accessible via communication network 130 and network communication link(s) 132/232.

Flowchart 380 continues with assigning the first guest to one of multiple groups each including other guests also seeking admission to first attraction 152 (action 383). In contrast to the self-identified groups described above by reference to action 381, the groups referenced by action 383 are determined by dynamic queue management software code 120/220a/220b/420 based at least on queue metrics 112/212/412 for the virtual queue of first attraction 152.

For example, when one of guests 116a-116d seeks admission to first attraction 152, dynamic queue management software code 120/220a/220b/420 may be configured to enforce business defined eligibility checks to the guest based on a variety of business rules. Where the guest seeks to enroll a self-defined group, those eligibility checks are applied to each member of the self-defined group individually, while still allowing a single guest to enroll the self-defined group. Examples of eligibility criteria may include how many virtual queues a guest can be enrolled in concurrently, whether the guest or guests are authorized to be present in venue 150, whether the guest or guests meet size or age requirements for admission to first attraction 152, and/or the physical proximity of the guest or guests to first attraction 152, to name a few. The eligibility checks described above serve to ensure that no individual or group obtains fraudulent or otherwise inappropriate admission to any attraction in venue 150.

Enrolled guests may then be sorted into predetermined group sizes that are variable by attraction type, based on queue metrics for a particular attraction. Merely by way of example, based on queue metrics 112/212/412, a group size for first attraction 152 in the form of a theme park entertainment venue or theme park ride may be predetermined to be five hundred (500) guests. In one implementation, individual guests or self-defined groups may be assigned to those groups having predetermined group sizes, filling up the groups sequentially until capacity is reached. The next guest or self-defined group may then be assigned to the next group in sequence. Thus, at least some of the other guests included in the group to which the first guest is assigned in action 383 will be strangers to the first guest.

In some implementations, assigning the first guest to a first one of multiple groups each including other guests also seeking admission to first attraction 152 may be performed by dynamic queue management software code 120/220a/420, executed by hardware processor 104/204, and using queue metrics analysis module 424. Alternatively, and as noted above, in some implementations, dynamic queue management software code 220b/420 stored locally on memory 276 of mobile communication device 160a/160b/260 may correspond substantially in full to dynamic queue management software code 120/220a/420. Thus, in some implementations, action 383 may be performed by dynamic queue management software code 220b/420, executed by hardware processor 274, and using queue metrics analysis module 424 accessible via communication network 130 and network communication link(s) 132/232.

Action 383 may include issuing a physical queue enrollment ticket for first attraction 152 or transmitting an electronic queue enrollment ticket for first attraction 152. For example, where first guest is guest 116a using ticketing kiosk 158, action 383 may result in ticketing kiosk 158 printing a physical queue enrollment ticket including the group number to which first guest 116a has been assigned, as well as identifying first attraction 152 to which the group is waiting to be admitted. Alternatively, where first guest is guest 116b using mobile communication device 160b/260 to enroll, action 383 may result in mobile communication device 160b/260 receiving or generating an electronic queue enrollment ticket including the group number to which first guest 116b has been assigned, as well as identifying first attraction 152 to which the group is waiting to be admitted.

As yet another alternative, where operator 118 of first attraction 152 uses mobile communication device 160a/260 to enroll first guest 116d, action 383 may result in mobile communication device 160a/260 displaying an electronic queue enrollment ticket including the group number to which first guest 116d has been assigned, as well as identifying first attraction 152 to which the group is waiting to be admitted. The queue enrollment tickets for first attraction 152 described above, whether physical or electronic, may include an alphanumeric code, or a QR Code™ or other matrix based code identifying first attraction 152 and the group to which the first guest has been assigned.

Where previous action 382 reveals that the first guest is also enrolled in the second virtual queue for second attraction 154, the first guest may be assigned to a group in action 383 based on that enrollment of the first guest in the second queue for admission to second attraction 154. For example, in one implementation, enrollment of the first guest in the second virtual queue for second attraction 154 may cause the first guest to be assigned to a group in the virtual queue for first attraction 152 having other members all or substantially all also enrolled in the second queue for second attraction 154.

It is noted that, in some implementations, the predetermined group size of groups including guests enrolled in multiple virtual queues may differ from the predetermined group size of groups of quests enrolled in a single virtual queue for a particular attraction. Moreover, the predetermined sizes of groups including guests enrolled in multiple virtual queues may vary from one another for a particular attraction based on the number of virtual queues those guests are enrolled in. In some implementations, for example, first attraction 152 and second attraction 154 may operate concurrently. In those implementations, grouping guests enrolled in both virtual queues together and/or varying the predetermined group size of those groups for the purposes of dynamic queueing may reduce or otherwise optimize the wait times for those guests with respect to admission to attractions 152 and 154.

Flowchart 380 continues with obtaining the current occupancy state of first attraction 152 (action 384). As noted above, queue metrics 112/212/412 for the virtual cue of first attraction 152 may include real-time operating metrics of first attraction 152, such as its current occupancy state and maximum occupancy. Thus, the current occupancy state of first attraction 152 may be obtained from attractions database 110/210/410 stored in memory 106/206 of system 100/200.

In some implementations, the current occupancy state of first attraction 152 may be obtained from attractions database 110/210/410 by dynamic queue management software code 120/220a/420, executed by hardware processor 104/204, and using queue metrics analysis module 424. Alternatively, and as also noted above, in some implementations, dynamic queue management software code 220b/420 stored locally on memory 276 of mobile communication device 160a/160b/260 may correspond substantially in full to dynamic queue management software code 120/220a/420. Thus, in some implementations, the current occupancy state of first attraction 152 may be obtained from attractions database 110/210/410 by dynamic queue management software code 220b/420, executed by hardware processor 274, via communication network 130 and network communication link(s) 132/232.

Flowchart 380 continues with determining the attendance period corresponding to the average time duration of attendance at first attraction 152 by previous guests of first attraction 152 (action 385). As noted above, queue metrics 112/212/412 for the virtual cue of first attraction 152 may include real-time operating metrics of first attraction 152, such as the time duration of attendance of all previous guests, recent previous guests, or previous guests selectively analyzed based on time of day, weekday, season, weather conditions, or any other criteria affecting attendance duration. As a result, the attendance period corresponding to the average time duration of attendance at first attraction 152 by previous guests of first attraction 152 may be determined based on queue metrics 112/212/412 for the virtual queue of first attraction 152.

In some implementations, the attendance period of first attraction 152 may be determined based on queue metrics 112/212/412 by dynamic queue management software code 120/220a/420, executed by hardware processor 104/204, and using queue metrics analysis module 424. Alternatively, and as also noted above, in some implementations, dynamic queue management software code 220b/420 stored locally on memory 276 of mobile communication device 160a/160b/260 may correspond substantially in full to dynamic queue management software code 120/220a/420. Thus, in some implementations, the attendance period of first attraction 152 may be determined based on queue metrics 112/212/412 by dynamic queue management software code 220b/420, executed by hardware processor 274.

Exemplary flowchart 380 may conclude with identifying one of the multiple groups including guests seeking admission to first attraction 152 for admission to first attraction 152 based on the number of guests included in the group, the current occupancy state of first attraction 152, and the attendance period of first attraction 152 (action 386). It is noted that in some implementations, the group identified for admission to first attraction 152 in action 386 may be the same group to which the first guest is assigned in action 383. However, in other implementations, the group identified for admission to first attraction 152 in action 386 may be another of the multiple groups each including other guests also seeking admission to first attraction 152.

As noted above, in some implementations, guests enrolled in the virtual queue for first attraction 152 may also be enrolled in a second virtual queue for second attraction 154. In those implementations, action 386 may also include obtaining queue metrics 114/214/414 describing the second queue for second attraction 154 and identifying the group for admission to first attraction 152 based on the queue metrics 114/214/414 describing the second queue. In a manner analogous to that described above by reference to obtaining queue metrics 112/212/412, queue metrics 114/214/414 describing the second virtual queue for second attraction 154 may be obtained from attractions database 110/210/410.

In some implementations, action 386 may be performed by dynamic queue management software code 120/220a/420, executed by hardware processor 104/204, and using queue metrics analysis module 424. Alternatively, and as noted above, in some implementations, dynamic queue management software code 220b/420 stored locally on memory 276 of mobile communication device 160a/160b/260 may correspond substantially in full to dynamic queue management software code 120/220a/420. Thus, in some implementations, action 386 may be performed by dynamic queue management software code 220b/420, executed by hardware processor 274.

Although not included in the exemplary outline provided by flowchart 380, in some implementations, the present method may include summoning the group identified in action 386 for admission to first attraction 152. Summoning of a group for admission to first attraction 152 may include outputting summons 134/234/434 for rendering on public display screen 156 of venue 150. Alternatively, or in addition, summoning of a group for admission to first attraction 152 may include generating summons 134/234/434 and/or rendering summons 134/234/444 using display 266 and/or speaker(s) 238 of mobile communication device 160a/160b/260.

According to some implementations, summons 134/234/434 may be generated and output by dynamic queue management software code 120/220a/420, executed by hardware processor 104/204, and using summoning module 428. Alternatively, in some implementations, summons 134/234/434 may be generated by dynamic queue management software code 220b/420, executed by hardware processor 274 of mobile communication device 160a/160b/260, and using summoning module 428 accessible via communication network 130 and network communication link(s) 132/232. Thus, in some implementations, the summoning is performed via dynamic queue management software code 220b/420 resident on mobile communication devices in the possession of at least some guests included in the group identified for admission to first attraction 152 in action 386.

In some implementations, it may be advantageous or desirable to identify an expiration time interval for the admission of the group identified in action 386 to first attraction 152, and to expire that admission if the group does not enter first attraction 152 within the expiration time interval. In some implementations, expiration of the admission of the group identified in action 386 may be performed by dynamic queue management software code 120/220a/420, executed by hardware processor 104/204, and using expiration module 426. Alternatively, in some implementations, expiration of the admission of the group identified in action 386 may be performed by dynamic queue management software code 220b/420, executed by hardware processor 274 of mobile communication device 160a/160b/260, and using expiration module 426 accessible via communication network 130 and network communication link(s) 132/232.

In implementations in which the admission to first attraction 152 by the group identified in action 386 is expired, hardware processor 104/204 may execute dynamic queue management software code 120/220a/420, or hardware processor 274 may execute dynamic queue management software code 220b/420, to identify an updated occupancy state of first attraction 152, determine an updated attendance period of first attraction 152, and identify another group for admission to first attraction 152 based on the number of guests included in that other group, the updated occupancy state of first attraction 152, and the updated attendance period of first attraction 152.

Thus, the present application discloses systems and methods for providing dynamic management of virtual queues that overcome the drawbacks and deficiencies in the conventional art. As discussed above, the systems and methods disclosed herein advantageously enable the management of large, fluctuating guest demand for a limited capacity attraction in real-time, while simultaneously mitigating fraud and ensuring the attraction is never starved of a guest population. Moreover, the present solution advantageously enables guests enrolled in a virtual queue for one attraction to experience other attractions available in a venue while advancing in the virtual queue.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory storing a dynamic queue management software code;
the hardware processor being configured to execute the dynamic queue management software code to:
receive a queue enrollment data identifying a first guest and a first attraction to which the first guest seeks admission;
determine whether the first guest is enrolled in a second queue for a second attraction to which the first guest also seeks admission;
assign the first guest to a first one of a plurality of groups each including other guests also seeking admission to the first attraction, wherein when the first guest is enrolled in the second queue, the first guest is assigned to the first one of the plurality of groups based on the first guest being enrolled in the second queue for admission to the second attraction;
obtain a current occupancy state of the first attraction;
determine an attendance period corresponding to an average time duration of attendance at the first attraction by previous guests of the first attraction; and
identify a second one of the plurality of groups for admission to the first attraction based on a number of guests included in the second one of the plurality of groups, the current occupancy state of the first attraction, and the attendance period.

2. The system of claim 1, wherein the hardware processor is configured to execute the dynamic queue management software code to further summon the second one of the plurality of groups for admission to the first attraction.

3. The system of claim 2, wherein the summoning is performed via a public display screen.

4. The system of claim 2, wherein the summoning is performed via software resident on mobile communication devices in the possession of at least some guests included in the second one of the plurality of groups.

5. The system of claim 1, wherein the first attraction and the second attraction operate concurrently.

6. The system of claim 1, wherein the hardware processor is configured to execute the dynamic queue management software code to further:
obtain queue metrics describing the second queue for the second attraction;
wherein identifying the second one of the plurality of groups for admission to the first attraction is further based on the queue metrics describing the second queue.

7. The system of claim 1, wherein at least some of the other guests included in the first one of the plurality of groups to which the first guest is assigned are strangers to the first guest.

8. The system of claim 1, wherein the hardware processor is configured to execute the dynamic queue management software code to further:
identify an expiration time interval for the admission;
expire the admission if the second one of the plurality of groups does not enter the first attraction within the expiration time interval;
identify an updated occupancy state of the first attraction;
determine an updated attendance period of the first attraction; and
identify a third one of the plurality of groups for admission to the first attraction based on a number of guests included in the third one of the plurality of groups, the updated occupancy state of the first attraction, and the updated attendance period of the first attraction.

9. The system of claim 1, wherein at least one of the first attraction and the second attraction comprises a theme park entertainment venue.

10. The system of claim 1, wherein at least one of the first attraction and the second attraction comprises a theme park ride.

11. A method for use by a system including a computing platform having a hardware processor and a system memory storing a dynamic queue management software code, the method comprising:
receiving, by the dynamic queue management software code executed by the hardware processor, a queue enrollment data identifying a first guest and a first attraction to which the first guest seeks admission;
determining, by the dynamic queue management software code executed by the hardware processor, whether the first guest is enrolled in a second queue for a second attraction to which the first guest also seeks admission;
assigning, by the dynamic queue management software code executed by the hardware processor, the first guest to a first one of a plurality of groups each including other guests also seeking admission to the first attraction, wherein when the first guest is enrolled in the second queue, the first guest is assigned to the first one of the plurality of groups based on the first guest being enrolled in the second queue for admission to the second attraction;
obtaining, by the dynamic queue management software code executed by the hardware processor, a current occupancy state of the first attraction;
determining, by the dynamic queue management software code executed by the hardware processor, an attendance period corresponding to an average time duration of attendance at the first attraction by previous guests of the first attraction; and
identifying, by the dynamic queue management software code executed by the hardware processor, a second one of the plurality of groups for admission to the first attraction based on a number of guests included in the second one of the plurality of groups, the current occupancy state of the first attraction, and the attendance period.

12. The method of claim 11, further comprising summoning, by the dynamic queue management software code executed by the hardware processor, the second one of the plurality of groups for admission to the first attraction.

13. The method of claim 12, wherein the summoning is performed via a public display screen.

14. The method of claim 12, wherein the summoning is performed via software resident on mobile communication devices in the possession of at least some guests included in the second one of the plurality of groups.

15. The method of claim 11, wherein the first attraction and the second attraction operate concurrently.

16. The method of claim 11, further comprising:
obtaining, by the dynamic queue management software code executed by the hardware processor, queue metrics describing the second queue for the second attraction;
wherein identifying the second one of the plurality of groups for an admission to the first attraction is further based on the queue metrics describing the second queue.

17. The method of claim 11, wherein at least some of the other guests included in the first one of the plurality of groups to which the first guest is assigned are strangers to the first guest.

18. The method of claim 11, further comprising:
identifying, by the dynamic queue management software code executed by the hardware processor, an expiration time interval for the admission;
expiring, by the dynamic queue management software code executed by the hardware processor, the admission if the second one of the plurality of groups does not enter the first attraction within the expiration time interval;
identifying, by the dynamic queue management software code executed by the hardware processor, an updated occupancy state of the first attraction;
determining, by the dynamic queue management software code executed by the hardware processor, an updated attendance period of the first attraction; and
identifying, by the dynamic queue management software code executed by the hardware processor, a third one of the plurality of groups for admission to the first attraction based on a number of guests included in the third one of the plurality of groups, the updated occupancy state of the first attraction, and the updated attendance period of the first attraction.

19. The method of claim 11, wherein at least one of the first attraction and the second attraction comprises a theme park entertainment venue.

20. The method of claim 11, wherein at least one of the first attraction and the second attraction comprises a theme park ride.
